(19) United States
(12) Patent Application Publication
(10) Pub. No.: US 2023/0147297 A1
(43) Pub. Date: May 11, 2023

(54) COORDINATION BETWEEN OVERLAPPING WEB CONFERENCES

(71) Applicant: INTERNATIONAL BUSINESS MACHINES CORPORATION, ARMONK, NY (US)

(72) Inventors: YOSHIYUKI BAN, Yamato-shi (JP); Daisuke Maruyama, Yamato-shi (JP)

(21) Appl. No.: 17/453,783

(22) Filed: Nov. 5, 2021

(51) Int. Cl. G06Q 10/10; H04L 12/18; H04M 3/56

(52) U.S. Cl. CPC G06Q 10/1095; H04L 12/1818; H04M 3/565

(57) ABSTRACT

A method, computer system, and a computer program product for meeting schedule conflict resolution are provided. A registration for a first virtual meeting that includes a first list of persons scheduled to virtually attend, a first meeting time, and a host is received. A registration for a second virtual meeting that includes a second list of persons scheduled to virtually attend, a second meeting time, and another host is received. A time overlap of the first meeting time and the second meeting time is identified. A meeting schedule conflict that includes a first person being in the first list and in the second list is identified. The meeting schedule conflict is resolved via generating and transmitting a coordinating message to at least one of the host and the other host.

### BACKGROUND

The present invention relates generally to systems for semi-automatically or automatically coordinating meeting attendance for overlapping virtual meetings, for example, for semi-automatically or automatically coordinating between overlapping virtual meetings within the same company or organization.

### SUMMARY

According to one exemplary embodiment, a method for meeting schedule conflict resolution is provided. A registration for a first virtual meeting that includes a first list of persons scheduled to virtually attend, a first meeting time, and a host is received via a computer. A registration for a second virtual meeting that includes a second list of persons scheduled to virtually attend, a second meeting time, and another host is received via the computer. A time overlap of the first meeting time and the second meeting time is identified via the computer. A meeting schedule conflict that includes a first person being in the first list and in the second list is identified via the computer. The meeting schedule conflict is resolved via the computer generating and transmitting a coordinating message to at least one of the host and the other host. A computer system and computer program product corresponding to the above method are also disclosed herein.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a meeting schedule conflict resolution process according to at least one embodiment;

FIG. 3 is an operational flowchart illustrating a meeting schedule conflict resolution process according to at least one other embodiment;

FIG. 4 is an operational flowchart illustrating a meeting schedule conflict resolution process according to at least one other embodiment;

FIG. 5 shows a meeting management system according to at least one embodiment;

FIG. 6A shows a coordinating message according to at least one embodiment;

FIG. 6B shows another coordinating message according to at least one embodiment;

FIG. 7 is a block diagram of internal and external components of computers, phones, and servers depicted in FIG. 1 according to at least one embodiment;

FIG. 8 is a block diagram of an illustrative cloud computing environment including the computer system depicted in FIG. 1, in accordance with an embodiment of the present disclosure; and

FIG. 9 is a block diagram of functional layers of the illustrative cloud computing environment of FIG. 8, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The following described exemplary embodiments provide a method, computer system, and computer program product for virtual meeting coordination that occurs semi-automatically or automatically. Business, schools, social groups, etc. are spending more time using virtual meetings in which users at different physical locations communicate and share information with each other via audio-visual technology, computers, and network communications such as the internet. Some companies or organizations use virtual meeting tools which prevent a person from simultaneously virtually attending multiple virtual meetings. Sometimes a company member or organization member may be expected to participate in multiple meetings, some of which may have a time overlap. It is practically difficult to actively participate in multiple meetings occurring simultaneously. It is difficult to understand and follow simultaneously the discussions of multiple meetings that are occurring at the same time. Such a company member or organization member may have unclarity about the priority of conflicting meetings. The present embodiments may help with coordination of a situation with conflicting meetings without requiring a personal call to be placed to an individual company member or organization member. The present embodiments may help facilitate participation of one or more key persons in both an ongoing meeting and a next meeting and may help reduce the impact of meeting delays due to meeting conflicts with other meetings. The negotiating features of the present embodiments allow more flexibility for meeting attendance adjustment, e.g., in a case of a non-predefined unexpected situation occurring. The present embodiments may enable a reorganizing of a meeting agenda to help a key person to join two overlapping meetings at key times. The present embodiments facilitate meeting conflict negotiation to occur between individuals best suited mentally, situationally, circumstantially, and/or emotionally to perform such negotiation. The present embodiments may facilitate one or more interactions between hosts of multiple virtual meetings. Thus, the present embodiments improve virtual meeting software.

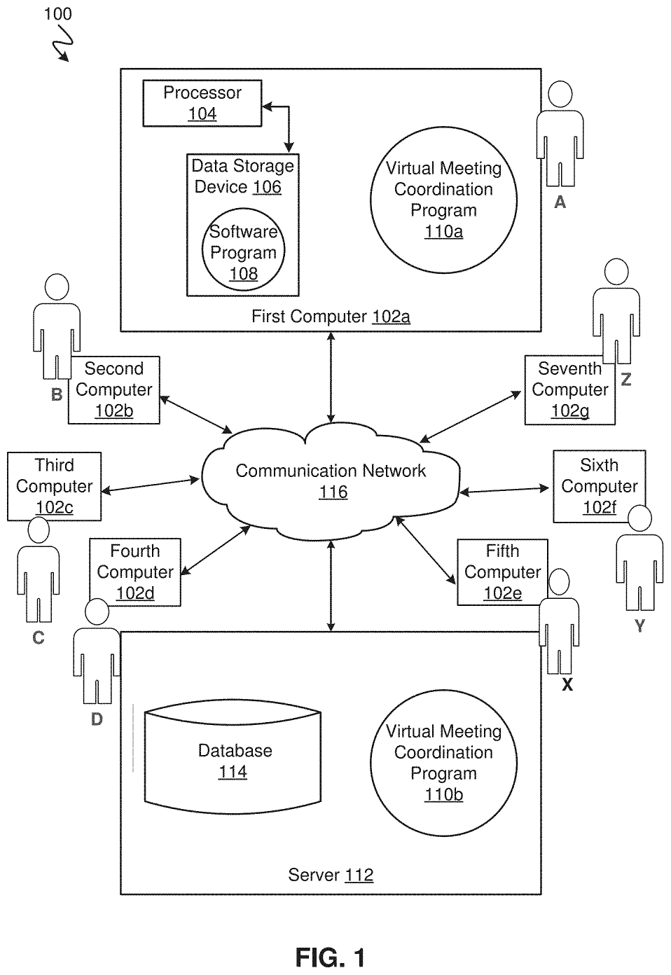

Referring to FIG. 1, a networked computer environment 100 in accordance with one embodiment is depicted. The networked computer environment 100 may include many individual computers. For example, first, second, third, fourth, fifth, sixth, and seventh computers 102a, 102b, 102c, 102d, 102e, 102f, and 102g, respectively. Elements or components are show for the first computer 102a, but the other computers, such as the second, third, fourth, fifth, sixth, and seventh computers 102b, 102c, 102d, 102e, 102f, and 102g, respectively, may have equivalent versions of those elements or components that are shown for the first computer 102a. The first computer 102a may include a processor 104 and a data storage device 106 and may be enabled to run a software program 108 and virtual meeting coordination program 110a. The networked computer environment 100 may also include a server 112 that is a computer and that is enabled to run virtual meeting coordination program 110b that may interact with a database 114. The various computers, e.g., the first computer 102a, the second computer 102b, the third computer 102c, the fourth computer 102d, the fifth computer 102e, the sixth computer 102f, the seventh computer 102g, and the server 112, may communicate with each other via a communication network 116. The networked computer environment 100 may include many computers and many servers, although seven computers and one server 112 are shown in FIG. 1. The communication network 116 allowing communication between the first computer 102a, the second computer 102b, the third computer 102c, the fourth computer 102d, the fifth computer 102e, the sixth computer 102f, the seventh computer 102g, and the server 112 may include various types of communication networks, such as the Internet, a wide area network (WAN), a local area network (LAN), a telecommunication network, a wireless network, a public switched telephone network (PTSN) and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

The first computer 102a may communicate with the server 112 and with the second, third, fourth, fifth, sixth, and seventh computers 102b, 102c, 102d, 102e, 102f, and 102g, respectively, via the communication network 116. The communication network 116 may include connections, such as wire, wireless communication links, or fiber optic cables. The communication network 116 may itself include multiple servers such as a network edge server and an edge/gateway server which may be enabled to run or assist in operation of the virtual meeting coordination. The communication network 116 may in some embodiments be or include high speed networks such as 4G and 5G networks. Implementing the present virtual meeting coordination in a 5G network will enable at least some embodiments to be implemented on the edge in order to boost network performance.

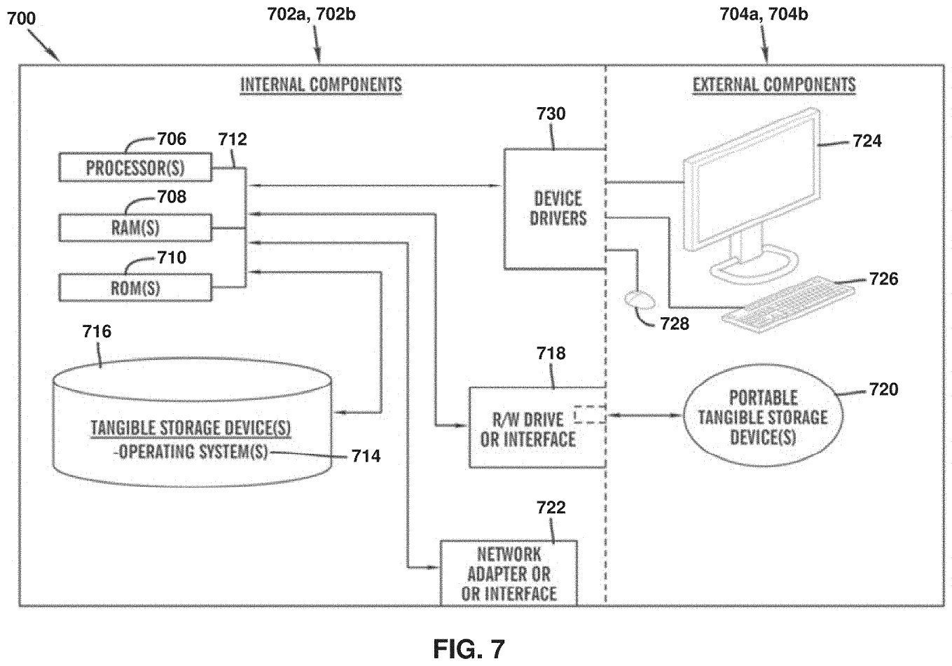

As will be discussed with reference to FIG. 7, the server 112 may include internal components 702a and external components 704a, respectively. The first computer 102a, the second computer 102b, the third computer 102c, the fourth computer 102d, the fifth computer 102e, the sixth computer 102f, and the seventh computer 102g may also each include internal components 702b and external components 704b as depicted in FIG. 7. Server 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. The first computer 102a, the second computer 102b, the third computer 102c, the fourth computer 102d, the fifth computer 102e, the sixth computer 102f, and the seventh computer 102g may each be, for example, a mobile device, a telephone, a personal digital assistant, a netbook, a laptop computer, a tablet computer, a desktop computer, or any type of computing devices capable of running a program, accessing a network, and accessing a database 114 in a server 112 that is remotely located with respect to the first computer 102a, the second computer 102b, the third computer 102c, the fourth computer 102d, the fifth computer 102e, the sixth computer 102f, and the seventh computer 102g. The first computer 102a, the second computer 102b, the third computer 102c, the fourth computer 102d, the fifth computer 102e, the sixth computer 102f, and the seventh computer 102g may each include a display screen, a speaker, a microphone, a camera, and a keyboard or other input device for better presenting audiovisual material used in virtual meetings, for recording audiovisual material to transmit to others who are participating in a virtual meeting, for receiving and presenting virtual meeting content, and to provide feedback to presentations. According to various implementations of the present embodiment, the virtual meeting coordination program 110a, 110b may interact with a database 114 that may be embedded in various storage devices, such as, but not limited to a various computers/mobile devices, a server 112 that may be in a network, or another cloud storage service.

Usage of storing content on edge servers may reduce network traffic that is required for execution of virtual meetings for which conflicting attendance may be coordinated according to the present embodiments described herein. This reduction in network traffic may help achieve efficient processing for execution of the methods according to the present embodiments. As virtual meeting hosts and participants log into virtual meetings via their respective computers, the host and other participants may utilize their network infrastructure to gain appropriate connectivity, e.g., 5G connectivity, into the environment. The present embodiments may take advantage of existing and future 5G infrastructure and its increase of bandwidth, latency, and scaling of applications requiring large amounts of real-time data. The server 112 may trigger data and command flows to be processed by distributed enhanced experience capability programs that are available at a network edge server located at a network edge and/or that are available at an edge/gateway server located at a network gateway. Summarization of meeting conflict negotiation messages and responses may flow from the edge gateway/server through the network edge server for access by the server 112 which implements virtual meeting coordination.

A virtual meeting host as described herein may refer to a person who administratively manages a virtual meeting, e.g., by registering, scheduling, and/or initiating the virtual meeting. A virtual meeting host as described herein may refer to a person who leads the discussion or presentation for a virtual meeting. A host may refer to a person who has some delegated responsibility from another person who may be considered to be the owner of the virtual meeting. A virtual meeting may be referred to as a web meeting, a webinar, etc.

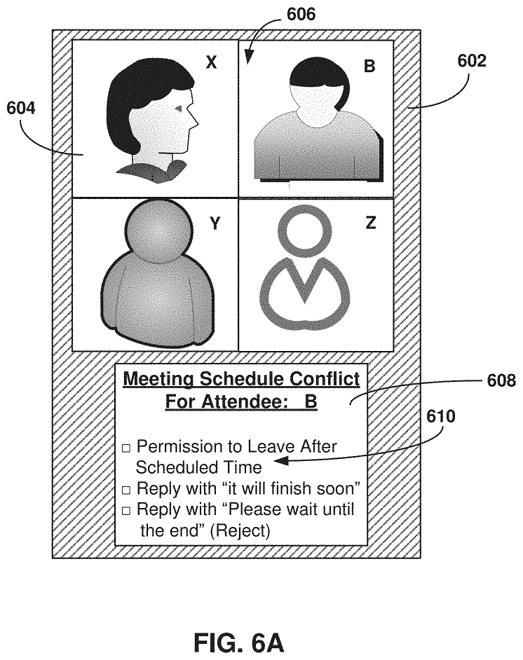

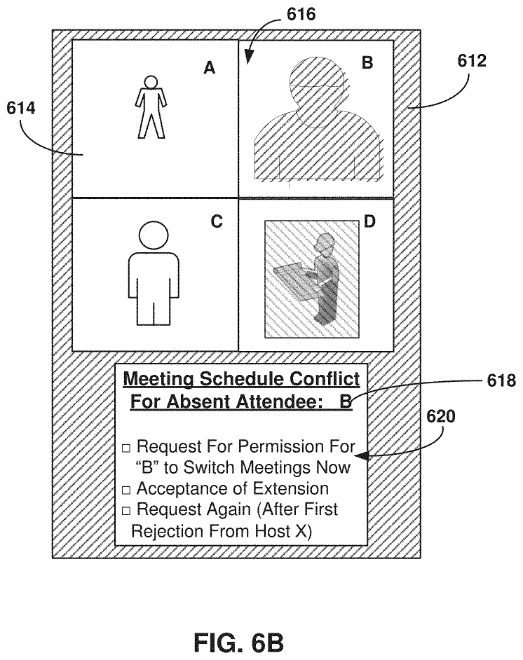

FIG. 1 depicts a first person “A” who may use the first computer 102a to participate in virtual meetings, a second person “B” who may use the second computer 102b to participate in virtual meetings, a third person “C” who may use the third computer 102c to participate in virtual meetings, a fourth person “D” who may use the fourth computer 102d to participate in virtual meetings, a fifth person “X” who may use the fifth computer 102e to participate in virtual meetings, a sixth person “Y” who may use the sixth computer 102f to participate in virtual meetings, and a seventh person “Z” who may use the seventh computer 102g to participate in virtual meetings. Online depictions of these first, second, third, fourth, fifth, sixth, and seventh persons A, B, C, D, X, Y, Z are also shown in FIGS. 6A and 6B which will be further described subsequently.

A computer system with the virtual meeting coordination program 110a, 110b operates as a special purpose computer system in which the virtual meeting coordination program 110a, 110b assists in the management and coordination of virtual meetings. In particular, the virtual meeting coordination program 110a, 110b transforms a computer system which contains/hosts it into a special purpose computer system as compared to currently available general computer systems that do not have the virtual meeting coordination program 110a, 110b.

The virtual meeting coordination program 110a, 110b can be implemented in various ways, in different embodiments of the invention. For example, the virtual meeting coordination program 110a, 110b may be implemented as a plugin that operates in conjunction with digital meeting software program and/or with calendaring programs. The digital meeting software program may include WebEx® (WebEx and all WebEx-based trademarks and logos are trademarks or registered trademarks of Cisco Technology, Inc. and/or its affiliates) and/or ZOOM™ (Zoom is a trademark of Zoom Video Communications, Inc.). The digital meeting software program may be used in order to conduct a digital or virtual meeting between users at the various computers such as “A”, “B”, “C”, “D”, “X”, “Y”, and “Z” at the first, second, third, fourth, fifth, sixth, or seventh computers 102a, 102b, 102c, 102d, 102e, 102f, and 102g, respectively. Digital meeting software program may be installed on all or some of first, second, third, fourth, fifth, sixth, and seventh computers 102a, 102b, 102c, 102d, 102e, 102f, and 102g in order to enable the virtual meetings to occur and to enable the transmission of image and audio components from the various computers to the other computers logged onto the same virtual meeting. The digital meeting software program may include screen sharing features and a chat function allowing text chat between meeting participants. Calendaring programs such as those associated with email programs may be used to help organize schedules and schedule meetings for a person and within an organization. The software program 108 depicted in FIG. 1 may represent a digital meeting program and/or a calendaring program, so that the virtual meeting coordination program 110a operates as a plug-in to the software program 108. The virtual meeting coordination program 110a may alternatively execute as a plug-in to an internet browser through which a virtual meeting program is being operated. The virtual meeting coordination program 110a, 110 b may alternatively execute as a dedicated software application which incorporates virtual meeting capabilities between computers.

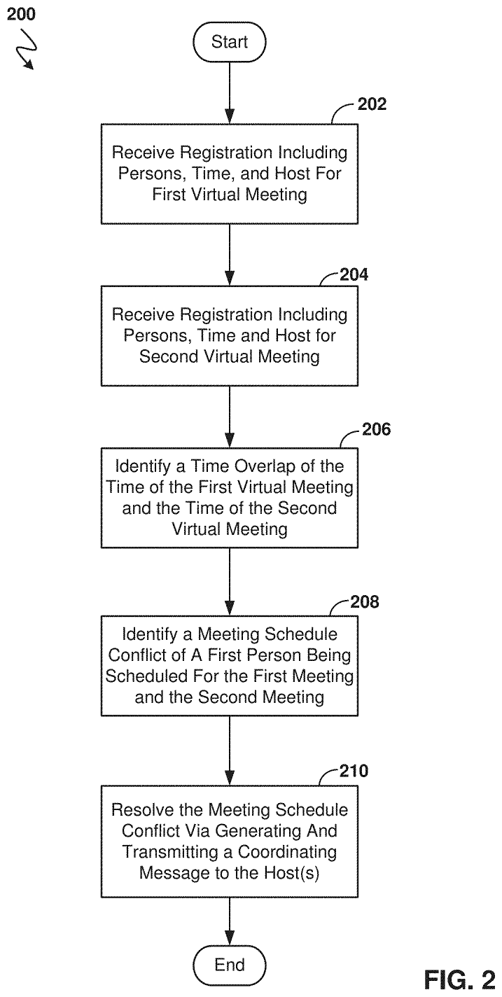

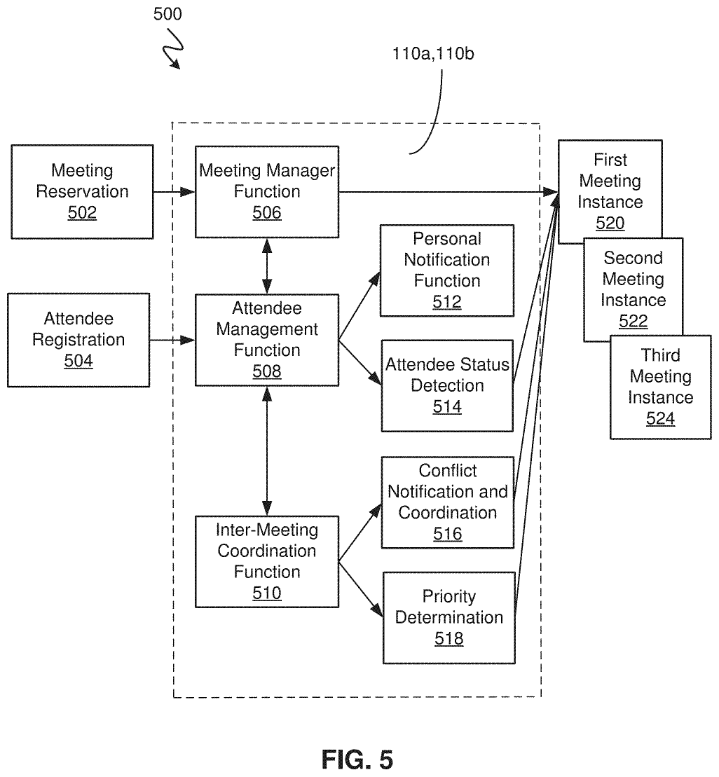

The virtual meeting coordination program 110a, 110b may be used to perform processes that are described in FIGS. 2, 3, and 4 and may be used to perform functions that are depicted in FIG. 5.

Referring now to FIG. 2, an operational flowchart depicts a virtual meeting coordination process 200 that may, according to at least one embodiment, be performed using the virtual meeting coordination program 110a, 110b. The virtual meeting coordination program 110a, 110b may include various modules, user interfaces, services, and virtual meeting tools and may use data storage when the virtual meeting coordination process 200 is performed.

In a step 202 of the virtual meeting coordination process 200, a registration including persons, time, and host for a first virtual meeting is received. The persons may refer to a list of persons that are scheduled or required to attend the first virtual meeting, with the virtual meeting coordination program 110a, 110b receiving this list as part of step 202. The virtual meeting coordination program 110b at the server 112 may receive the registration including the list of persons, meeting time, and host via a data transmission through the communication network 116. An owner of the first virtual meeting may supply or generate the registration that is transmitted to the virtual meeting coordination program 110b at the server 112. The receipt of this meeting registration may result in a meeting instance being started at the meeting scheduled start time.

This owner may also be the host for the virtual meeting that is to take place. For example, the person “X” shown in FIG. 1 associated with the fifth computer 102e may be the host for the first virtual meeting as will subsequently be depicted in FIG. 6A. This host may administratively manage the first virtual meeting and/or may lead the discussion or presentation for the first virtual meeting.

A virtual meeting coordination program instance at the second computer 102b may generate a graphical user interface for presentation via the second computer 102b which allows the person “B” to provide registration information such as meeting time, identity of host, and scheduled list of persons who should or are asked to attend the first virtual meeting. The receiving described in step 202 may alternatively refer to a virtual meeting coordination program local instance, e.g., the virtual meeting coordination program 110a, receiving information entered in by at the respective local computer, e.g., by the person “A” at the first computer 102a. The receiving described in step 202 may refer to a person, e.g., person “B”, typing in information into a keyboard connected to the second computer 102b.

The virtual meeting coordination program 110a may also have an application programming interface connection to the digital meeting software program installed on the first computer 102a and/or an application programming interface connection to the calendaring software installed on the first computer 102a. This application programming interface connection may allow the virtual meeting coordination program 110a to receive, from the digital meeting software program and/or from the calendaring program, a notification of meeting acceptance or meeting registration for a meeting owner or participant.

The registration may be stored in memory that is part of or accessible to the virtual meeting coordination program 110a, 110b. For example, meeting content may be saved in the database 114 shown in FIG. 1, in the RAM 708 that is shown in FIG. 7, in memory of a server connected to the communication network 116, and/or in other memory in one or more remote servers that is accessible to the virtual meeting coordination program 110a, 110b via the communication network 116 and/or via a wired connection.

In a step 204 of the virtual meeting coordination process 200, a registration including persons, time, and host for a second virtual meeting is received. The persons may refer to a list of persons that are scheduled or required to attend the second virtual meeting, with the virtual meeting coordination program 110a, 110b receiving this list as part of step 204. The virtual meeting coordination program 110b at the server 112 may receive the registration including the list of persons, meeting time, and host via a data transmission through the communication network 116. An owner of the second virtual meeting may supply or generate the registration that is transmitted to the virtual meeting coordination program 110b at the server 112. The receipt of this meeting registration may result in a meeting instance being started at the meeting scheduled start time.

This owner may also be the host for the virtual meeting that is to take place. For example, the person “A” shown in FIG. 1 associated with the first computer 102a may be the host for the second virtual meeting as will subsequently be depicted in FIG. 6B. This host may administratively manage the second virtual meeting and/or may lead the discussion or presentation for the second virtual meeting.

The second virtual meeting may have a scheduled start time which is after a scheduled start time for the first virtual meeting.

In a step 206 of the virtual meeting coordination process 200, a time overlap of the time of the first virtual meeting and a time of the second virtual meeting is identified. The virtual meeting coordination program 110a, 110b may include a data comparator which compares time blocks to identify time overlaps and/or overlapping time blocks. The data comparator may in some embodiments perform synchronization and/or consolidation to different time data sets if these time data sets being compared are not initially sufficiently compatible to each other for the comparison. The synchronization may include altering a data organization of the time blocks in a first time data set to match the data organization of the time blocks in a second time data set. The virtual meeting coordination program 110a, 110 may search the text of the various time data sets in an organization meeting time database to identify specific time blocks for which multiple meetings have been scheduled in a particular time. The virtual meeting coordination program 110a, 110b may include a main calendar for an organization, company, division, and/or team which tracks virtual meetings within the respective unit. Each registration occupies a time block on a virtual calendar that corresponds to a time period of a day of a week and month. When a subsequent registration seeks to enter into a time block that is already occupied by a prior registration, the virtual meeting coordination program 110a, 110b recognizes the time overlap.

In some embodiments, this identification of step 206 occurs before both the first virtual meeting and the second virtual meeting have started. In other embodiments, this identification of step 206 occurs after the first virtual meeting has started but before the second virtual meeting has started.

In some embodiments, this identification of step 206 occurs due to an unregistered time extension of a first virtual meeting so that due to the time extension this first virtual meeting then overlaps with a scheduled meeting start time for a second virtual meeting. The virtual meeting coordination program 110a, 110b may monitor the duration and/or completion of a virtual meeting and thereby may identify when a virtual meeting extends temporally longer than expected. Such an unregistered time extension may via this monitoring be entered into the virtual meeting coordination program 110a, 110b and may constitute part of a time update to the registration that was received in step 202 or in step 204. For example, a first virtual meeting may have been registered to end at a set time, e.g., 2:00 PM and a second virtual meeting may have been registered to begin at that set time, e.g., 2:00 PM. If and once the first virtual meeting runs overtime, the first and second virtual meetings then have a time overlap.

The virtual meeting coordination process 200 depicted in FIG. 2 refers to first and second virtual meetings being registered and monitored. In practice, the virtual meeting coordination process 200 may apply for a greater number of virtual meetings being registered and monitored.

The identification of step 206 may occur in a virtual meeting coordination program local instance, e.g., at the virtual meeting coordination program 110a at the first computer 102a or at a corresponding virtual meeting coordination program at one of the other computers, and/or at the virtual meeting coordination program 110b at the server 112.

In a step 208 of the virtual meeting coordination process 200, a meeting schedule conflict of a first person who is scheduled for the first meeting and the second meeting is identified. A data comparator of the virtual meeting coordination program 110a, 110b may compare names of those registered or requested to attend the first virtual meeting with names of those registered or requested to attend the second virtual meeting. Such a data comparator may implement text comparison features to compare names of multiple lists to identify individuals who are registered to attend multiple meetings. If individuals are represented in a company database with another identifier besides a name, e.g., an employee identification number, the data comparator may compare such other identifiers to identify a meeting schedule conflict. Such meeting schedule conflict occurs when a particular person is expected to be attending two different virtual meetings, at least part of which are happening at the same day and time. A match of names may be a perfect letter match or a letter match above a threshold level that may occur when a person is listed by a partial name or nickname on one list and not on another list.

The identification of step 208 may occur in a virtual meeting coordination program local instance, e.g., at the virtual meeting coordination program 110a at the first computer 102a or at a corresponding virtual meeting coordination program instance at one of the other computers such as the second, third, fourth, fifth, sixth, and/or seventh computers 102b, 102c, 102d, 102e, 102f, 102g, and/or at the virtual meeting coordination program 110b at the server 112.

In a step 210 of the virtual meeting coordination process 200, the meeting schedule conflict is resolved via generating and transmitting a coordinating message to the host(s). This generating may occur at the virtual meeting coordination program 110b at the server 112, with the generated coordinating message then being transmitted via the communication network 116 to one or more of the first, second, third, fourth, fifth, sixth, and/or seventh computers 102a, 102b, 102c, 102d, 102e, 102f, 102g.

The virtual meeting coordination program 110b may store as part of the registration the name or identity of the host for a particular virtual meeting and then transmit this coordinating message to the location, e.g., the computer, that the host is using. For example, for the virtual meeting depicted in FIG. 6A the person “X” was designated as the host for the first virtual meeting. Thus, for step 210 a coordinating message may be transmitted via the communication network 116 from the server 112 to the fifth computer 102e because the person “X” is using the fifth computer 102e to participate in and to host the first virtual meeting. Similarly, for the second virtual meeting depicted in FIG. 6B the person “A” was designated as the host for the second virtual meeting. For step 210 a coordinating message may be transmitted via the communication network 116 from the server 112 to the first computer 102a because the person “A” is using the first computer 102a to participate in the second virtual meeting. Alternatively, the transmission may occur from a virtual meeting coordination program local instance at one or more of the local computers, e.g., at the first, second, third, fourth, fifth, sixth, or seventh computers 102a, 102b, 102c, 102d, 102e, 102f, 102g, respectively, and be transmitted to a display of the respective local computer, e.g., at a computer display monitor 724 that is depicted in FIG. 7.

The first coordinating message 608 shown in FIG. 6A and the second coordinating message 618 shown in FIG. 6B are examples of coordinating messages that may be generated and transmitted as a part of step 210 of the virtual meeting coordination process 200. The content of such first and second coordinating messages 608, 618 may be the different or the same. In the exemplary embodiments shown in FIGS. 6A and 6B, the content of the first coordinating message 608 is different from the content of the second coordinating message 618.

FIG. 6A shows an exemplary display screen of the host of the first virtual meeting. In this example the host, e.g., indicated with the first host depiction 604, is person “X”. This first meeting host display 602 includes a first meeting participants display 606 which shows or indicates who is participating in and/or has joined into this particular virtual meeting from their respective local computer. In this example, persons “X”, “B”, “Y”, and “Z” are indicated and/or shown in the first meeting participants display 606 as being joined in, connected to, and/or participating in the first virtual meeting. In this example in which the person “X” is the host for this first virtual meeting, the first meeting host display 602 is being displayed on a display screen associated with the fifth computer 102e, e.g., on a display monitor 724 connected to the fifth computer 102e.

FIG. 6A shows at the bottom of the first meeting host display 602 the first coordinating message 608 that has been transmitted to and received by the display screen and/or the fifth computer 102e. The first coordinating message 608 indicates that person “B” has a current meeting schedule conflict. The first coordinating message 608 also includes one or more conflict resolution proposals, a first conflict resolution proposal 610 that is “Permission to Leave After Scheduled Time” being labeled in FIG. 6A. Other conflict resolution proposals that are part of a first coordinating message 608 may include “Reply with ‘it will finish soon’” (referring to the first virtual meeting), “Reply with ‘Please wait until the end’ (Reject)”, “It will be extended for about xx minutes”, “Permission For All Schedule Conflicted Attendees To Leave”, and Permission For All Attendees To Leave”. For the last possibility listed above, the host may be given an opportunity to enter in a specific time amount or an estimate for a specific time amount for how much longer the meeting will continue until the meeting ends. This response and time amount may be transmitted to the host of the other meeting.

The first meeting host display 602 may also be a graphical user interface which allows user feedback from a user sitting at the respective display screen. The first coordinating message 608 that is displayed as part of the first meeting host display 602 may allow user feedback, e.g., a response, to the first coordinating message 608 to be indicated by the user, e.g., by the person “X” who is viewing the first meeting host display 602 at the fifth computer 102e. Specifically, a user may be able to indicate acceptance of one or more of the displayed conflict resolution proposals, e.g., of the first conflict resolution proposal 610. The respective coordinating message may include a respective checkbox for the corresponding conflict resolution proposals. A user may click on the respective checkbox by moving a cursor on the screen by moving a computer mouse 728 associated with the fifth computer 102e and then actuating a button on the computer mouse 728 when the cursor is placed in the respective checkbox on the display screen. Other proposal acceptance signals may be generated from user input into other input tools, e.g., into a keyboard, microphone, etc., of the respective computer, e.g., the fifth computer 102e.

The feedback, e.g., one or more responses, that is indicated may be transmitted to the virtual meeting coordination program 110a, 110b to allow the virtual meeting coordination program 110a, 110b to process the feedback.

The meeting host displays, e.g., the first meeting host display 602, may include other information such as the current time, the scheduled end time of the respective meeting, and any meeting time length overrun that the meeting is having with respect to a scheduled end time.

FIG. 6B shows an exemplary display screen of the host of the second virtual meeting. In this example the host, e.g., indicated with the second host depiction 614, is person “A”. This second meeting host display 612 includes a second meeting participants display 616 which shows or indicates who is participating in and/or has joined into this particular virtual meeting from their respective local computer. In this example, persons “A”, “C”, and “D” are indicated and/or shown in the second meeting participants display 616 as being joined in, connected to, and/or participating in the second virtual meeting. In this example, person “B” is indicated and/or shown as being assigned or expected to participate in the second virtual meeting but as being currently absent from the second virtual meeting. This absence may constitute a failure by the person “B” to virtually connect their second computer 102b to the second virtual meeting. In this example in which the person “A” is the host, e.g., the host shown in the second host depiction 614, for this second virtual meeting, the second meeting host display 612 is being displayed on a display screen associated with the first computer 102a, e.g., on a display monitor 724 connected to the first computer 102a.

FIG. 6B shows at the bottom of the second meeting host display 612 the second coordinating message 618 that has been transmitted to and received by the display screen and/or the first computer 102a. The second coordinating message 618 indicates that person “B” has a current meeting schedule conflict. The second coordinating message 618 also includes one or more further conflict resolution proposals, a leading further conflict resolution proposal 620 that is “Request For Permission For ‘B’ to Switch Meetings Now” being labeled in FIG. 6B. Other further conflict resolution proposals that are part of a second coordinating message 618 may include “Acceptance of Extension”, “Request Again (After First Rejection From Host X)”, and “Permission For Conflicted Attendee(s) To Leave Requested”, and “Accept Response from Host of First Virtual Meeting”. The “Acceptance of Extension” may apply in the embodiment where a meeting schedule conflict resulted for one or more meeting participants due to a time extension of the first virtual meeting, e.g., for the first virtual meeting extending longer than its scheduled time duration that was indicated in the registration.

The second meeting host display 612 may also be a graphical user interface which allows user feedback from a user sitting at the respective display screen similar as was described above for the first meeting host display 602.

The meeting host displays, e.g., the second meeting host display 612, may include other information such as the current time, the scheduled end time of the respective meeting, and any meeting time length overrun that the meeting is having with respect to a scheduled end time.

The meeting host displays, e.g., the first meeting host display 602 and the second meeting host display 612, may include other information such as a meeting priority level that was indicated in the registration by either the meeting owner or by an attendee, a meeting attendee roll for the first meeting and another meeting attendee roll for the second meeting for attendees with current meeting schedule conflicts, a number of meeting attendees with a current meeting schedule conflict, a type of the other meeting that is part of the schedule conflict, an implied priority level of the other meeting based on the type of the other meeting, a percentage of overall meeting attendees with a current meeting schedule conflict, remaining agenda points to be covered for the current meeting, and meeting participation level of any attendee with a current meeting schedule conflict.

An overall meeting priority level may be reduced after a scheduled end time of the meeting has been exceeded by the meeting running over time. This reduction may be indicated via the meeting priority level displayed to the meeting host and/or the meeting attendees. In embodiments with rule-based switching of meetings for attendees with meeting schedule conflicts, this reduction may be implemented by shifting the meeting priority level that is to be input into a meeting priority algorithm which weighs and determines the meeting importance for a particular attendee as compared to the meeting importance for the other meeting the particular attendee is scheduled to attend.

A meeting priority level specific to a particular attendee may be reduced or increased based on a participation level of the attendee in a meeting. If an attendee provided no or few remarks in a first meeting, the first meeting may be designated as having a low priority level for this particular attendee. If another attendee provided some or many remarks in that first meeting or in another meeting, such may be designated as having a high priority level for this particular attendee. The level of participation may be based on number of remarks, frequency of remarks, duration of remarks, frequency of responding to online questions presented in the meeting, e.g., via a poll displayed through the meeting software, etc. A reduction or increase in meeting priority level for a particular user may be indicated via the meeting priority level displayed to the meeting host and/or the meeting attendees. In embodiments with rule-based switching of meetings for attendees with meeting schedule conflicts, this reduction or increase may be implemented by shifting the meeting priority level to be input into a meeting priority algorithm which weighs and determines the meeting importance for a particular attendee as compared to the meeting importance for the other meeting the particular attendee is scheduled to attend.

An overall meeting priority level may be reduced based on a number of meeting attendees or a percentage of overall meeting attendees with a current meeting schedule conflict exceeding a threshold amount. This reduction may be indicated via the meeting priority level displayed to the meeting host and/or the meeting attendees. In embodiments with rule-based switching of meetings for attendees with meeting schedule conflicts, this reduction may be implemented by shifting the meeting priority level that is to be input into a meeting priority algorithm which weighs and determines the meeting importance for a particular attendee as compared to the meeting importance for the other meeting the particular attendee is scheduled to attend. For example, if three or more of the attendees of the first meeting have a meeting conflict towards the end of the first meeting, the first meeting may receive a reduction in priority level. Also for example, if thirty percent or more of the attendees of the first meeting have a meeting conflict towards the end of the first meeting, the first meeting may receive a reduction in priority level.

An overall meeting priority level may be set based on a meeting priority level that was set in the meeting registration, e.g., by the meeting owner. A range of meeting priority levels may include, from most to least important, a strategy meeting, an important meeting, and a normal meeting. This meeting priority level may be indicated in the display of the meeting host and/or the meeting attendees. In embodiments with rule-based switching of meetings for attendees with meeting schedule conflicts, this meeting priority level may be input into a meeting priority algorithm which weighs and determines the meeting importance for a particular attendee as compared to the meeting importance for the other meeting the particular attendee is scheduled to attend.

An overall meeting priority level may be adjusted based on meeting contents that are left to be covered in an initial meeting as was indicated in the meeting registration, e.g., by the meeting owner. In some instances, a meeting agenda may be input as part of the registration. A range of meeting content priority levels may include, from most to least important, content for decision making, content for information sharing, and content for a seminar meeting. This meeting content priority level of the remaining meeting points may be indicated in the display of the meeting host and/or the meeting attendees. In embodiments with rule-based switching of meetings for attendees with meeting schedule conflicts, this meeting content priority level of the remaining meeting points may be input into a meeting priority algorithm which weighs and determines the meeting importance for a particular attendee as compared to the meeting importance for the other meeting the particular attendee is scheduled to attend. For rule-based switching the virtual meeting program 110a, 110b may operate in a fully automated manner after the registration information is received. The rule-based switching may be performed using a machine learning model in which meeting factors described herein, meeting roles, and meeting schedules are input into the machine learning model and in response the model outputs meeting importance ranking and/or coordination messages corresponding to meeting importance ranking. Certain coordination messages, e.g., “Request for permission to switch” or “ReRequest for permission to switch” may be most appropriate for high priority meetings that are being missed by a schedule conflicted individual. Lower priority meetings may correspond to other coordination messages such as “Please estimate overrun/meeting ending time”. Users may provide feedback to the ranking that the machine learning model may use to enhance its system in a manner similar to supervised learning. In other embodiments which rely on responses from the virtual meeting hosts being received for meeting conflict resolution, the virtual meeting coordination process described in the foregoing may occur in a semi-automated manner.

An overall meeting priority level may be set based on an attendee role for the conflicting meetings as was set in the meeting registration, e.g., by the meeting owner. A range of attendee roles may include, from most to least important, a host, a presenter, a decision maker, and a listener. This attendee role may be indicated in the display of the meeting host and/or the meeting attendees. In embodiments with rule-based switching of meetings for attendees with meeting schedule conflicts, this attendee role may be input into a meeting priority algorithm which weighs and determines the meeting importance for a particular attendee as compared to the meeting importance for the other meeting the particular attendee is scheduled to attend.

An overall meeting priority level may be set based on a priority level set in the meeting registration, e.g., by the meeting owner. A range of priority levels may include, from most to least important, mandatory and optional. This priority level may be indicated in the display of the meeting host and/or the meeting attendees. In embodiments with rule-based switching of meetings for attendees with meeting schedule conflicts, this priority level may be input into a meeting priority algorithm which weighs and determines the meeting importance for a particular attendee as compared to the meeting importance for the other meeting the particular attendee is scheduled to attend. In some embodiments with rule-based switching, this set priority level may be the only factor input into a meeting priority algorithm which weighs and determines the meeting importance for a particular attendee as compared to the meeting importance for the other meeting the particular attendee is scheduled to attend.

An overall meeting priority level may be set based on a rating given by the attendee when the attendee accepts attendance responsibility for a particular meeting or accepts an invitation to participate in this virtual meeting. This priority level may be indicated in the display of the meeting host and/or the meeting attendees. In embodiments with rule-based switching of meetings for attendees with meeting schedule conflicts, this priority level may be input into a meeting priority algorithm which weighs and determines the meeting importance for a particular attendee as compared to the meeting importance for the other meeting the particular attendee is scheduled to attend. In some embodiments with rule-based switching, this set priority level may be the only factor input into a meeting priority algorithm which weighs and determines the meeting importance for a particular attendee as compared to the meeting importance for the other meeting the particular attendee is scheduled to attend.

In some embodiments, hosts of both the first virtual meeting and the second virtual meeting may provide a response to the respective coordinating message that was received. The responses may be transmitted to the virtual meeting coordination program 110a, 110b to allow the virtual meeting coordination program 110a, 110b to process the feedback. The virtual meeting coordination program 110a, 110b may compare the feedback, e.g., the two responses, to help resolve the meeting schedule conflict. Generating and transmitting coordination messages and responses to coordination messages may be repeated until the meeting schedule conflict is resolved.

In some embodiments, part of the second coordinating message 618 will not be generated and transmitted to the host of the second virtual meeting until the response to the first coordinating message 608 is received from the host of the first virtual meeting. For example, a “Request Again” message may not be generated and transmitted to the host of the second virtual meeting until the host “X” of the first virtual meeting rejects a leave request. In the examples shown in FIGS. 1 and 6A of the drawings this host of the first virtual meeting may be the person “X”. Then the resolving may include the virtual meeting coordination program 110a, 110b subsequently receiving the response to the second coordinating message 618 from the host of the second virtual meeting. In the examples shown in FIGS. 1 and 6B of the drawings this host of the second virtual meeting may be the person “A”.

In some embodiments, part of the first coordinating message 608 will not be generated and transmitted to the host of the first virtual meeting until the response to the second coordinating message 618 is received from the host of the second virtual meeting. For example, a “Permission to Leave Now” message may not be generated and transmitted to the host of the second virtual meeting until the host “A” of the second virtual meeting requests that person “B” immediately be switched over to other meeting. In the examples shown in FIGS. 1 and 6A of the drawings this host of the second virtual meeting may be the person “A”. Then the resolving may include the virtual meeting coordination program 110a, 110b subsequently receiving the response to the first coordinating message 608 from the host of the first virtual meeting. In the examples shown in FIGS. 1 and 6B of the drawings this host of the first virtual meeting may be the person “X”.

In at least some embodiments, all or part of the first coordinating message 608 and the second coordinating message 618 may be generated and transmitted simultaneously, with the first coordinating message 608 being transmitted to the host of the first virtual meeting and the second coordinating message 618 being transmitted to the host of the second virtual meeting.

The resolving of the conflict may result in the status quo continuing until the end of the first meeting. The resolving of the conflict may result in an immediate switch of the conflicted attendee to the second meeting. The resolving of the conflict may result in a delayed switch of the conflicted attendee to the second meeting.

FIGS. 6A and 6B show an example conflict in which a single person “B” has a meeting schedule conflict between the first virtual meeting and the second virtual meeting. In other embodiments, more than one person may have a meeting schedule conflict between multiple virtual meetings.

In at least some embodiments, the coordinating message generated and transmitted includes the generation and transmission of a respective chat box that is sent to the computers of the first and second meeting hosts which facilitates a live chat between the two hosts. The chat box may include an introductory message requesting the respective host to work out a schedule conflict resolution with the other host. Any response typed into the chat box of one of the hosts may be transmitted via the communication network 116 to be displayed in the chat box being displayed on the computer screen of the other host. In some embodiments a host may be given, via a prompt button, the option of accepting a chat box with an anonymous chat in which the name of the other host(s) is not indicated. The chat box feature may be applied for various steps including for steps 210, 318, and/or 432. This chat box may be generated and facilitated for the two hosts despite the two hosts being in different meetings that are simultaneously occurring in one or more digital meeting programs. Natural language processing may be performed on words, phrases, and/or sentences that are typed or entered by one or both of the hosts into the respective chat box. The natural language processing may be used to determine a message tone, intensity, resolving conclusion, etc. from the chat box words. These determined message characteristics and/or terms may be input into a machine learning model for refinement of the coordination processing and to assist in generation of coordinating messages for future uses of the machine learning model to resolve meeting conflicts.

Negotiation preferences and/or responses of the hosts may be saved in a memory that is part of the virtual meeting coordination program 110a, 110b or that is accessible to the virtual meeting coordination program 110a, 110b. For example, negotiation preferences and/or responses may be saved in the database 114 shown in FIG. 1, in the RAM 708 that is shown in FIG. 7, in memory of an edge/gateway server or network edge server, and/or in other memory in one or more remote servers that are accessible to the virtual meeting coordination program 110a, 110b via the communication network 116. Storing the negotiation preferences at memory of an edge/gateway server may reduce network traffic that is required during the virtual meeting coordination. These preferences and/or responses may also be input into a machine learning model hosted by or accessible to the virtual meeting coordination program 110a, 110b. This input may result in the machine learning model being trained as part of a training phase. In subsequent uses of the virtual meeting coordination program 110a, 110b to resolve meeting schedule conflicts, the virtual meeting coordination program 110a, 110b may input the host name/identity into the trained machine learning model and the trained machine learning model may output, as part of an inference phase, a negotiation prompt to be part of the coordinating message that is generated and transmitted to the particular host. Thus, the virtual meeting coordination program 110a, 110b may in some embodiments incorporate a machine learning model. This machine learning model may be in addition to or separate from the above-described rules-based machine learning model.

In some embodiments, the virtual meeting coordination process 200 may include an additional step of saving conflict negotiation preferences and/or responses for one or more of the hosts. These saved preferences and/or responses may be used during subsequent iterations of the virtual meeting coordination process 200. For example, in these subsequent performances of the virtual meeting coordination process 200, coordinating messages may be generated at least based in part on the stored negotiation preferences and/or stored responses for a particular host. These negotiation preferences and/or responses may be stored in memory that is part of the virtual meeting coordination program 110a, 110b or in memory that is accessible to the virtual meeting coordination program 110a, 110b. For example, the negotiation preferences and/or responses may be saved in the database 114 shown in FIG. 1, in the RAM 708 that is shown in FIG. 7, in memory of an edge/gateway server or of a network edge server, and/or in other memory in one or more remote servers that are accessible to the virtual meeting coordination program 110a, 110b via the communication network 116. Storing the negotiation preferences at memory of an edge/gateway server may reduce network traffic that is required during the virtual meeting coordination. These preferences and/or host identities may also be input into the machine learning model. This machine learning model may rank meeting priorities and may help generate appropriate coordination messages. This inputting of this data into the machine learning model may be a training phase and may constitute training the machine learning model for future iterations of overlapping virtual meeting coordination. During such future iterations, the machine learning model may suggest personalized negotiation responses and questions to a host which the host had previously typed into a chat box during a previous instance of coordinating a conflict between overlapping virtual meetings.

The conflicting meetings described above and below may be occurring through a single digital software virtual meeting program or via different software virtual meeting programs. A company or organization may use a single digital software virtual meeting program for all intra company meetings. In this instance, the virtual meeting coordination program 110a, 110b may be a plug-in program that works on top of the specific particular digital software virtual meeting program.

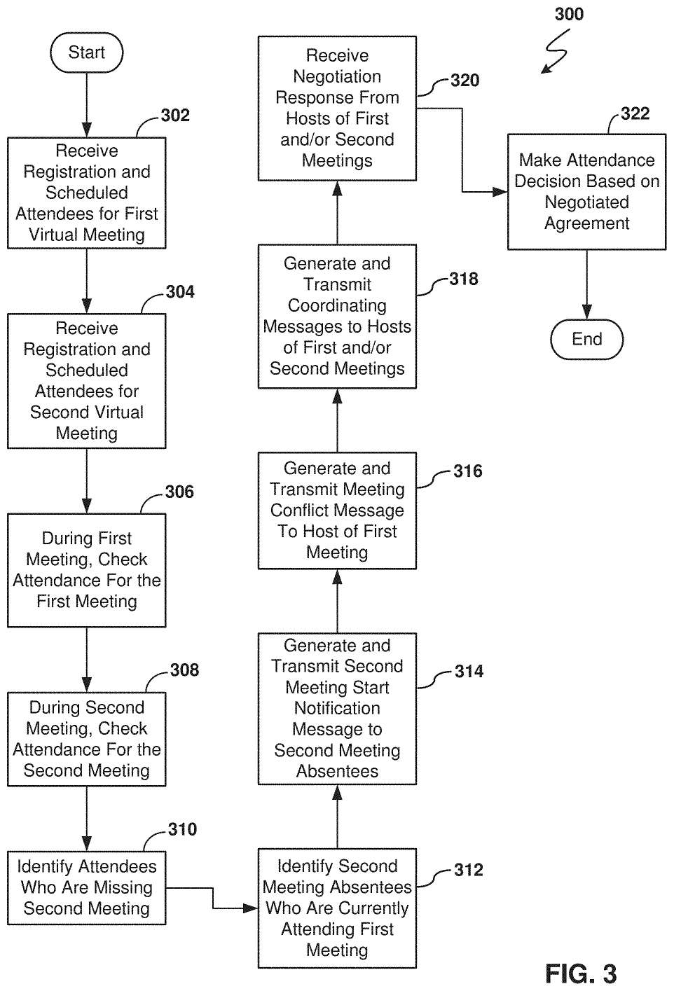

Referring now to FIG. 3, an operational flowchart depicts an enhanced virtual meeting coordination process 300 that may, according to at least one embodiment, be performed using the virtual meeting coordination program 110a, 110b. The virtual meeting coordination program 110a, 110b may include various modules, user interfaces, services, and virtual meeting tools and may use data storage when the enhanced virtual meeting coordination process 300 is performed. The enhanced virtual meeting coordination process 300 has many steps and features which overlap with the virtual meeting coordination process 200 described above and shown in FIG. 2.

In a step 302 of the enhanced virtual meeting coordination process 300, a registration and scheduled attendees for a first virtual meeting are received. This step 302 may occur equivalently to the step 202 of the virtual meeting coordination process 200 that was described previously and shown in FIG. 2.

In a step 304 of the enhanced virtual meeting coordination process 300, a registration and scheduled attendees for a second virtual meeting are received. This step 304 may occur equivalently to the step 204 of the virtual meeting coordination process 200 that was described previously and shown in FIG. 2.

In a step 306 of the enhanced virtual meeting coordination process 300, attendance for the first virtual meeting is checked during the first virtual meeting. The virtual meeting coordination program 110a, 110b may use an application programing interface (API) connection to the digital meeting software program or virtual meeting attendance tracking software to receive information about attendance at the first virtual meeting and to receive a list of attendees who are currently connected to the first virtual meeting. A company or organization using digital meeting software program may have login or other identification information for any computer that joins a virtual meeting. This login information may be used to identify a meeting attendee. The digital meeting software may recognize when an external computer joins the meeting and exits the meeting by closing the browser or application through which the virtual meeting is being displayed.

In a step 308 of the enhanced virtual meeting coordination process 300, attendance for the second virtual meeting is checked during the second virtual meeting. The virtual meeting coordination program 110a, 110b may use an application programing interface (API) connection to the digital meeting software program or virtual meeting attendance tracking software to receive information about attendance at the second virtual meeting and to receive a list of attendees who are currently connected to the second virtual meeting. A company or organization using digital meeting software program may have login or other identification information for any computer that joins a virtual meeting. This login information may be used to identify a meeting attendee. The digital meeting software may recognize when an external computer joins the meeting and exits the meeting by closing the browser or application through which the virtual meeting is being displayed.

In a step 310 of the enhanced virtual meeting coordination process 300, attendees who are missing the second virtual meeting are identified. The virtual meeting coordination program 110a, 110b may include a data comparator which compares entries from the registration that was received in step 304 to the list of current attendees that is received in step 308. Entries from the scheduled attendees which have a match in the list of current attendees may be removed, and the resulting list (original list minus those removals) represents those who are absent from the second virtual meeting.

In the example virtual second meeting described with respect to FIG. 6B of the drawings, the step 310 may indicate that persons “B” and “D” are absent from the meeting but were registered or required to attend. The hashing displayed through the personages of persons “B” and “D” in FIG. 6B may in one embodiment indicate absences of these two from the virtual meeting, i.e., the respective computer associated with these two persons has not logged into the second virtual meeting.

In a step 312 of the enhanced virtual meeting coordination process 300, second meeting absentees who are currently attending the first virtual meeting are identified. The virtual meeting coordination program 110a, 110b may include a data comparator which compares entries from the absentee list that was identified in step 310 to a list of first virtual meeting current attendees that is received in step 306. Entries of second virtual meeting absentees which do not have a match from the list of the first virtual meeting current attendees may be removed, and the resulting list represents those who are absent from the second virtual meeting and are simultaneously attending the first virtual meeting.

In the example virtual second and first meetings described with respect to FIGS. 6A and 6B of the drawings, the step 312 may indicate that person “B” is absent from the second meeting and is currently virtually attending the first virtual meeting.

In a step 314 of the enhanced virtual meeting coordination process 300, a second meeting start notification message is generated and transmitted to the second meeting absentees. The virtual meeting coordination program 110a, 110b may generate and transmit this meeting start notification message to all of those absentees who were identified in step 310. This meeting start notification message may occur via the digital meeting software program. The message may be generated at the server 112 shown in FIG. 1 and transmitted via the communication network 116 to the particular local computer which is associated with the respective meeting absentee. These meeting start notification messages may alternatively be transmitted via email to an email address associated with the absent person. These meeting start notification messages may alternatively be transmitted via a chat function of a communication program to which the absent persons belong, e.g., a communication program used by a company or organization for intra-company communication.

In the example virtual second meeting described with respect to FIG. 6B of the drawings, for the step 314 a meeting start notification message may be generated and transmitted to the second computer 102b that is associated with the person “B” and another meeting start notification message may be generated and transmitted to the fourth computer 102d that is associated with the person “D”. These messages may be generated at the server 112 and transmitted via the communication network 116. These messages indicate that the second virtual meeting has started.

In a step 316 of the enhanced virtual meeting coordination process 300, a meeting conflict message is generated and transmitted to the host of the first virtual meeting. The virtual meeting coordination program 110a, 110b may generate and transmit this meeting conflict message to the host of the first virtual meeting. The meeting conflict message may include an icon to be displayed on the screen of the computer of the host. Such icon may be displayed in a taskbar of the overall screen, in a taskbar associated with the virtual meeting program, and/or in a chat box generated for transmitting meeting coordinating messages. The host may be identified by the registration information that was received in step 302. The host may also or alternatively be identified by the computer which performed virtual meeting startup responsibilities and steps for the first virtual meeting which is in session. This meeting conflict message may be transmitted through the digital meeting software program. The message may be generated at the server 112 shown in FIG. 1 and transmitted via the communication network 116 to the particular local computer which is associated with the respective meeting host. In the examples described with respect to FIGS. 1, 6A, and 6B, this meeting conflict message may be generated and transmitted to the fifth computer 102e which is associated with the person “X” who is operating and/or is registered as the host for the first virtual meeting.

In a step 318 of the enhanced virtual meeting coordination process 300, coordinating messages to hosts of the first and/or second meetings are generated and transmitted. The virtual meeting coordination program 110a, 110b may generate and transmit the one or more coordinating messages to one or both of the hosts of the first and second virtual meetings. The hosts may be identified by the registration information that was received in steps 302 and 304. The hosts may also or alternatively be identified by the computers which performed virtual meeting startup responsibilities and steps for the first virtual meeting and the second virtual meeting which are currently being held. These coordinating messages may be transmitted through the digital meeting software program. The coordinating messages may be generated at the server 112 shown in FIG. 1 and transmitted via the communication network 116 to the particular local computer which is associated with the respective meeting host. In the examples described with respect to FIGS. 1, 6A, and 6B, a coordinating message may be generated and transmitted to the fifth computer 102e which is associated with the person “X” who is operating and/or is registered as the host for the first virtual meeting. A coordinating message may be generated and transmitted to the first computer 102a which is associated with the person “A” who is operating and/or is registered as the host for the second virtual meeting. These coordinating message(s) may have been input into a machine learning model initially as part of training the machine learning model and may have come from selected phrases or sentences of an owner or supervisor of the machine learning model. These coordinating message(s) may have been input into a machine learning model initially as part of a feedback loop when the person “X” or “A” had previously interacted with the virtual meeting coordination program 110a, 110b to resolve a conflict of overlapping virtual meetings and had at that previous time typed in a response into a chat box to communicate with the host of the other meeting.

Step 210 of the virtual meeting coordination process 200 described above and shown in FIG. 2 and displays shown in FIGS. 6A and 6B and the corresponding description above describe examples of coordinating messages that may be generated, transmitted, received, and displayed for step 318. In some embodiments chat boxes for the hosts may be generated for the hosts to communicate with each other. In some embodiments, a host may be given, via a prompt button, the option of accepting a chat box with an anonymous chat in which the name of the other host(s) is not indicated.

For messages that are transmitted, an application programming interface between the virtual meeting coordination program 110a, 110b and the digital meeting program may allow a message transmission from the virtual meeting coordination program 110b at the server 112 or via the virtual meeting coordination program local instance at one of the local computers to generate a message within the local digital meeting program instance at the respective local computer for display to the user at that local computer.

In a step 320 of the enhanced virtual meeting coordination process 300, one or more negotiation responses are received from hosts of the first and/or second meetings. Step 210 of the virtual meeting coordination process 200 described above and shown in FIG. 2 and displays shown in FIGS. 6A and 6B and the corresponding description above describe examples of responses to coordinating messages being be generated, transmitted, received, and displayed for step 320.

For steps 318 and 320, generating and transmitting coordination messages and negotiation responses to coordination messages may be repeated until the meeting schedule conflict is resolved.

In a step 322 of the enhanced virtual meeting coordination process 300, an attendance decision is made based on a negotiated agreement. The attendance decision may include the status quo continuing until the end of the first meeting. The attendance decision may include an immediate switch of the conflicted attendee to the second meeting. The attendance decision may include a delayed switch of the conflicted attendee to the second meeting. The delay may be an agreed upon length of time until the conflicted attendee is authorized to exit the first virtual meeting to attend the second virtual meeting. In embodiments with rule-based switching of meetings for attendees with meeting schedule conflicts, a meeting priority algorithm may be used to help determine the attendance decision. The negotiated agreement may include a first host of the first virtual meeting and a second host of the second virtual meeting agreeing on a conflict resolution for the conflicted attendee. This agreement may occur when the second host accepts the response of the first response. The second host may enter acceptance via engaging the graphical user interface which may display the response of the first host to the coordinating message.

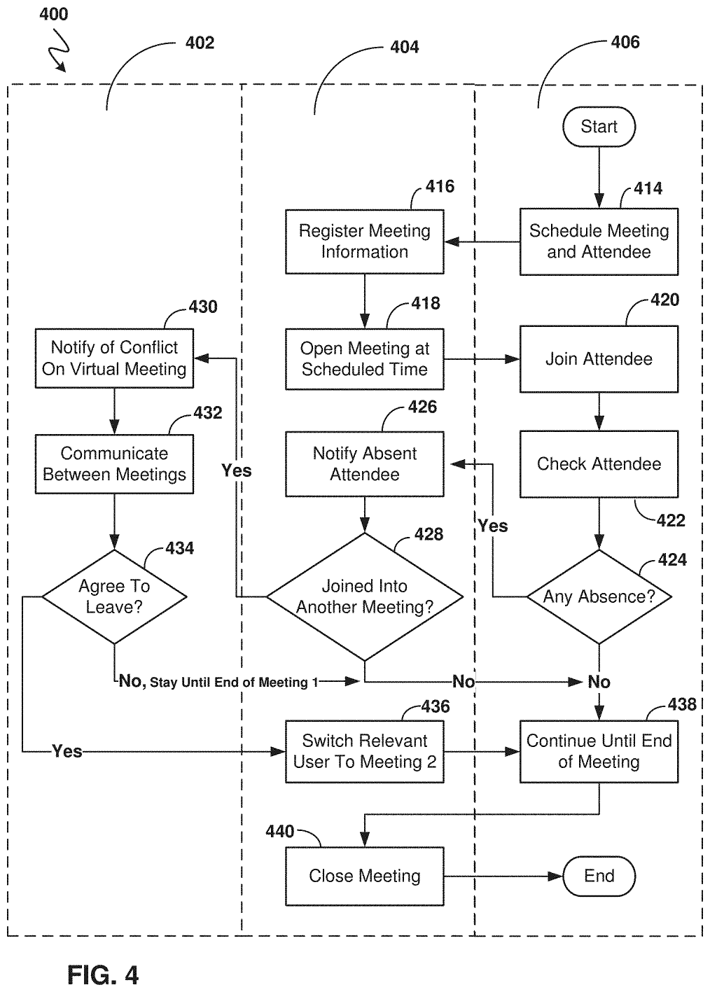

Referring now to FIG. 4, an operational flowchart depicts an additional virtual meeting coordination process 400 that may, according to at least one embodiment, be performed using the virtual meeting coordination program 110a, 110b. The virtual meeting coordination program 110a, 110b may include various modules, user interfaces, services, and virtual meeting tools and may use data storage when the additional virtual meeting coordination process 400 is performed. The additional virtual meeting coordination process 400 has many steps and features which overlap with the virtual meeting coordination process 200 described above and shown in FIG. 2 and with the enhanced virtual meeting coordination process 300 described above and shown in FIG. 3.

FIG. 4 shows various steps of the additional virtual meeting coordination process 400 being divided into three columns, namely a first virtual meeting column 402, a meeting system column 404, and a second virtual meeting column 406. The first virtual meeting column 402 includes steps that are part of a first virtual meeting that starts before a second virtual meeting starts. The meeting system column 404 includes steps that may be performed by the virtual meeting coordination program 110a, 110b. The second virtual meeting column 406 includes steps that are part of a second virtual meeting that starts after the first virtual meeting starts.

In a step 414 of the additional virtual meeting coordination process 400, a meeting is scheduled and attendees for the meeting are registered. This step 414 may be performed by a host or owner of the second virtual meeting directly engaging the virtual meeting coordination program 110a, 110b or indirectly engaging the virtual meeting coordination program 110a, 110b by first engaging a digital meeting software program or calendaring program which then engage the virtual meeting coordination program 110a, 110b. This step 414 may occur equivalently to part of the step 204 of the virtual meeting coordination process 200 that was described previously and shown in FIG. 2 and/or to part of the step 304 of the enhanced virtual meeting coordination process 300 that was described previously and shown in FIG. 3.

In a step 416 of the additional virtual meeting coordination process 400, the meeting information is registered. This step 416 may include the meeting information scheduled in step 414 being transmitted to the virtual meeting coordination program 110a, 110b, e.g., via the communication network 116, and then registered therein. This step 416 may occur equivalently to part of the step 204 of the virtual meeting coordination process 200 that was described previously and shown in FIG. 2 and/or to part of the step 304 of the enhanced virtual meeting coordination process 300 that was described previously and shown in FIG. 3.

In a step 418 of the additional virtual meeting coordination process 400, the meeting is opened at the scheduled time. This meeting that is opened in step 418 is the meeting that was scheduled in step 414 and whose information was registered in step 416. A host of this second virtual meeting may engage the digital meeting software to begin the second virtual meeting.

In a step 420 of the additional virtual meeting coordination process 400, one or more attendees join the meeting. This meeting is the meeting that was opened in step 418. Meeting attendees may access the digital meeting software at their own respective computer to join in and/or connect to the second virtual meeting.

In a step 422 of the additional virtual meeting coordination process 400, attendees are checked for the meeting. This checking may include checking virtual attendance at this virtual meeting. This step 422 may occur equivalently to the step 308 of the enhanced virtual meeting coordination process 300 that was described previously and shown in FIG. 3.

In a step 424 of the additional virtual meeting coordination process 400, a determination is made as to whether this virtual meeting has any absences. This determination may be an outcome of the attendance check that may occur in step 422. This check may include a comparison of all attendees that are registered to attend this virtual meeting and the list of current attendees that is currently joined in or connected to the virtual meeting. This step 424 may be equivalent to step 310 that of the enhanced virtual meeting coordination process 300 that was described previously and shown in FIG. 3. If the determination of step 424 is affirmative with a finding of a scheduled attendee who is absent, the additional virtual meeting coordination process 400 proceeds to step 426. If the determination of step 424 is negative with a finding of no scheduled attendee who is absent, the additional virtual meeting coordination process 400 proceeds to step 438.

In a step 426 of the additional virtual meeting coordination process 400, an absent attendee is notified. This step 426 may be similar or equivalent to the step 314 of the enhanced virtual meeting coordination process 300 that was described above and shown in FIG. 3. A message may be sent via the communication network 116 to the local computer associated with the absent attendee.

In a step 428 of the additional virtual meeting coordination process 400, a determination is made as to whether the absent attendee is joined into another meeting. This other meeting may be another virtual meeting. The virtual meeting coordination program 110a, 110b may track all other live virtual meetings in which company or organization members or are participating and/or which have been registered into the virtual meeting coordination program 110a, 110b. The virtual meeting coordination program 110a, 110b may continually track virtual attendance for each active meeting in their list and may compare a list of all current attendees in other meetings to the absent attendee identified earlier in this additional virtual meeting coordination process 400.

If the determination of step 428 is affirmative with a finding of the absent attendee being joined into another virtual meeting, the additional virtual meeting coordination process 400 proceeds to step 430. If the determination of step 424 is negative with a finding of the absent attendee not being joined into another registered virtual meeting, the additional virtual meeting coordination process 400 proceeds to step 438.

In a step 430 of the additional virtual meeting coordination process 400, a notification of a conflict on the virtual meeting is made. This virtual meeting may be part of the first virtual meeting column 402. This step 430 may be similar or equivalent to all or part of the step 210 of the virtual meeting coordination process 200 that was described earlier and shown in FIG. 2 and/or to all or part of the steps 316 and 318 of the enhanced virtual meeting coordination process 300 that was described earlier and shown in FIG. 3. This notification of a conflict may include generation and/or transmission of an icon to be displayed on the screen of the computer of the host. Such icon may be displayed in a taskbar of the overall screen, in a taskbar associated with the virtual meeting program, and/or in a chat box generated for transmitting meeting coordinating messages.

In a step 432 of the additional virtual meeting coordination process 400, communication between the meetings occurs. This refers to the host of the virtual meeting from the second virtual meeting column 406 communicating with the host of the virtual meeting from the first virtual meeting column 402. This step 432 may be similar or equivalent to all or part of the step 210 of the virtual meeting coordination process 200 that was described earlier and shown in FIG. 2 and/or to all or part of the steps 316, 318, and 320 of the enhanced virtual meeting coordination process 300 that was described earlier and shown in FIG. 3. Generating and transmitting coordination messages and responses to coordination messages may be repeated in step 432 until the meeting schedule conflict is resolved. In some embodiments chat boxes for the hosts may be generated for the hosts to communicate with each other. In some embodiments, a host may be given, via a prompt button, the option of accepting a chat box with an anonymous chat in which the name of the other host(s) is not indicated.

In a step 434 of the additional virtual meeting coordination process 400, a determination is made as to whether the host agrees for the absent attendee to leave the first virtual meeting to join the second virtual meeting. The negotiation responses that are received in step 432 may be analyzed to determine whether an agreement for meeting switching is achieved. If the determination of step 434 is affirmative with a finding of agreement for the meeting switching, the additional virtual meeting coordination process 400 proceeds to step 436. If the determination of step 434 is negative with a finding of no agreement for meeting switching, the additional virtual meeting coordination process 400 proceeds to step 438. The lack of agreement means that the attendee with the conflict will stay in the first virtual meeting until the end of the first virtual meeting.

In a step 436 of the additional virtual meeting coordination process 400, the relevant user is switched to the second virtual meeting. This step 436 may include the virtual meeting coordination program 110a, 110b blocking access of this relevant person from the first virtual meeting and automatically joining in the computer of this relevant person in to the second virtual meeting.

In a step 438 of the additional virtual meeting coordination process 400, the meeting continues until the end of the meeting. This meeting may be the second virtual meeting as it is shown as being disposed in the second virtual meeting column 406.

In a step 440 of the additional virtual meeting coordination process 400, the meeting is closed. The host of the second virtual meeting may close a meeting end button to perform step 440 after the allotted time is finished and/or after all agenda points have been covered.

The additional virtual meeting coordination process 400 may end after step 440.

FIG. 5 shows a meeting management system 500 according to at least one embodiment. The virtual meeting coordination program 110a, 110b may perform various meeting management functions as depicted and described below. The virtual meeting coordination program 110a, 110b may receive a meeting reservation 502 and an attendee registration 504. The virtual meeting coordination program 110a, 110b may perform a meeting manager function 506, an attendee management function 508, an inter-meeting coordination function 510, a personal notification function 512, an attendee status detection 514, a conflict notification and coordination 516, and a priority determination 518. The virtual meeting coordination program 110a, 110b may work with and manage first, second, and third meeting instances 520, 522, and 524 and may switch users between the first, second, and third meeting instances 520, 522, and 524 to resolve schedule conflicts between these meetings.

It may be appreciated that FIGS. 2-5, 6A, and 6B provide illustrations of some embodiments and do not imply any limitations with regard to how different embodiments may be implemented. Many modifications to the depicted embodiment(s), e.g., to a depicted sequence of steps, may be made based on design and implementation requirements. Steps and features from the various processes may be combined into the other processes that are described in other drawings or embodiments.

FIG. 7 is a block diagram 700 of internal and external components of computers depicted in FIG. 1 in accordance with an illustrative embodiment of the present invention. It should be appreciated that FIG. 7 provides only an illustration of one implementation and does not imply any limitations with regard to the environments in which different embodiments may be implemented. Many modifications to the depicted environments may be made based on design and implementation requirements.

Data processing system 702a, 702b, 704a, 704b is representative of any electronic device capable of executing machine-readable program instructions. Data processing system 702a, 702b, 704a, 704b may be representative of a smart phone, a computer system, PDA, or other electronic devices. Examples of computing systems, environments, and/or configurations that may represented by data processing system 702a, 702b, 704a, 704b include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The first, second, third, fourth, fifth, sixth, and seventh computers 102a, 102b, 102c, 102d, 102e, 102f, and 102g and server 112 may include respective sets of internal components 702a, 702b and external components 704a, 704b illustrated in FIG. 7. Each of the sets of internal components 702a, 702b includes one or more processors 706, one or more computer-readable RAMs 708 and one or more computer-readable ROMs 710 on one or more buses 712, and one or more operating systems 714 and one or more computer-readable tangible storage devices 716. The one or more operating systems 714, the software program 108, and the virtual meeting coordination program 110a in the first computer 102a, and the virtual meeting coordination program 110b in server 112 may be stored on one or more computer-readable tangible storage devices 716 for execution by one or more processors 706 via one or more RAMs 708 (which typically include cache memory). In the embodiment illustrated in FIG. 7, each of the computer-readable tangible storage devices 716 is a magnetic disk storage device of an internal hard drive. Alternatively, each of the computer-readable tangible storage devices 716 is a semiconductor storage device such as ROM 710, EPROM, flash memory, or any other computer-readable tangible storage device that can store a computer program and digital information.

Each set of internal components 702a, 702b also includes a RAY drive or interface 718 to read from and write to one or more portable computer-readable tangible storage devices 720 such as a CD-ROM, DVD, memory stick, magnetic tape, magnetic disk, optical disk or semiconductor storage device. A software program, such as the software program 108 and the virtual meeting coordination program 110a, 110b can be stored on one or more of the respective portable computer-readable tangible storage devices 720, read via the respective R/W drive or interface 718 and loaded into the respective hard drive, e.g., the tangible storage device 716.

Each set of internal components 702a, 702b may also include network adapters (or switch port cards) or interfaces 722 such as a TCP/IP adapter cards, wireless wi-fi interface cards, or 3G, 4G, or 5G wireless interface cards or other wired or wireless communication links. The software program 108 and the virtual meeting coordination program 110a in the first computer 102a and the virtual meeting coordination program 110b in the server 112 can be downloaded from an external computer (e.g., server) via a network (for example, the Internet, a local area network or other, wide area network) and respective network adapters or interfaces 722. From the network adapters (or switch port adaptors) or interfaces 722, the software program 108 and the virtual meeting coordination program 110a in the first computer 102a and the virtual meeting coordination program 110b in server 112 are loaded into the respective hard drive, e.g., the tangible storage device 716. The network may include copper wires, optical fibers, wireless transmission, routers, firewalls, switches, gateway computers and/or edge servers.

Each of the sets of external components 704a, 704b can include a computer display monitor 724, a keyboard 726, and a computer mouse 728. External components 704a, 704b can also include touch screens, virtual keyboards, touch pads, pointing devices, and other human interface devices. Each of the sets of internal components 702a, 702b also includes device drivers 730 to interface to computer display monitor 724, keyboard 726 and computer mouse 728. The device drivers 730, R/W drive or interface 718 and network adapter or interface 722 include hardware and software (stored in storage device 716 and/or ROM 710).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

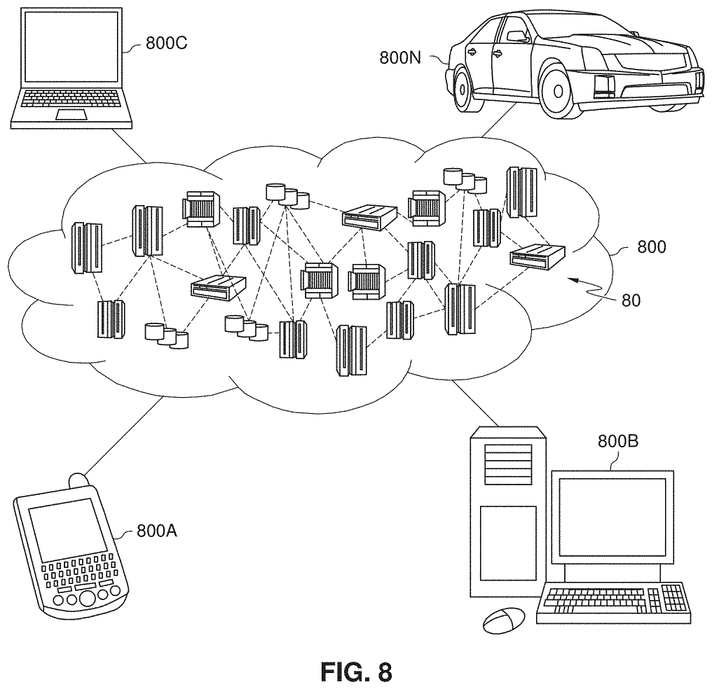

Referring now to FIG. 8, illustrative cloud computing environment 800 is depicted. As shown, cloud computing environment 800 comprises one or more cloud computing nodes 80 with which local computing devices used by cloud consumers, such as, for example, personal digital assistant (PDA) or cellular telephone 800A, desktop computer 800B, laptop computer 800C, and/or automobile computer system 800N may communicate. Nodes 80 may communicate with one another. They may be grouped (not shown) physically or virtually, in one or more networks, such as Private, Community, Public, or Hybrid clouds as described hereinabove, or a combination thereof. This allows cloud computing environment 800 to offer infrastructure, platforms and/or software as services for which a cloud consumer does not need to maintain resources on a local computing device. It is understood that the types of computing devices 800A-N shown in FIG. 8 are intended to be illustrative only and that computing nodes 80 and cloud computing environment 800 can communicate with any type of computerized device over any type of network and/or network addressable connection (e.g., using a web browser).

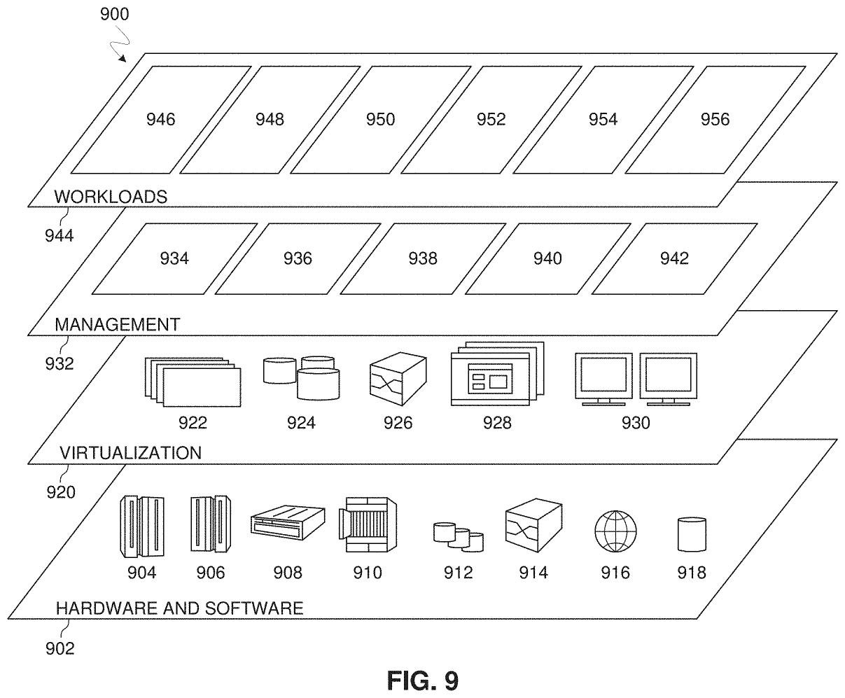

Referring now to FIG. 9, a set of functional abstraction layers 900 provided by cloud computing environment 800 is shown. It should be understood in advance that the components, layers, and functions shown in FIG. 8 are intended to be illustrative only and embodiments of the invention are not limited thereto. As depicted, the following layers and corresponding functions are provided:

Hardware and software layer 902 includes hardware and software components. Examples of hardware components include: mainframes 904; RISC (Reduced Instruction Set Computer) architecture based servers 906; servers 908; blade servers 910; storage devices 912; and networks and networking components 914. In some embodiments, software components include network application server software 916 and database software 918.

Virtualization layer 920 provides an abstraction layer from which the following examples of virtual entities may be provided: virtual servers 922; virtual storage 924; virtual networks 926, including virtual private networks; virtual applications and operating systems 928; and virtual clients 930.

In one example, management layer 932 may provide the functions described below. Resource provisioning 934 provides dynamic procurement of computing resources and other resources that are utilized to perform tasks within the cloud computing environment. Metering and Pricing 936 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 938 provides access to the cloud computing environment for consumers and system administrators. Service level management 940 provides cloud computing resource allocation and management such that required service levels are met. Service Level Agreement (SLA) planning and fulfillment 942 provide pre-arrangement for, and procurement of, cloud computing resources for which a future requirement is anticipated in accordance with an SLA.

Workloads layer 944 provides examples of functionality for which the cloud computing environment may be utilized. Examples of workloads and functions which may be provided from this layer include: mapping and navigation 946; software development and lifecycle management 948; virtual classroom education delivery 950; data analytics processing 952; transaction processing 954; and virtual meeting coordination 956. A virtual meeting coordination program 110a, 110b provides a way to help resolve meeting schedule conflicts within a company or organization.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for meeting schedule conflict resolution, the method comprising:
receiving, via a computer, a registration for a first virtual meeting, the registration including a first list of persons scheduled to virtually attend, a first meeting time, and a host;
receiving, via the computer, a registration for a second virtual meeting, the registration including a second list of persons scheduled to virtually attend, a second meeting time, and another host;
identifying, via the computer, a time overlap of the first meeting time and the second meeting time;
identifying, via the computer, a meeting schedule conflict comprising a first person being in the first list and in the second list; and
resolving, via the computer, the meeting schedule conflict via generating and transmitting a coordinating message to at least one of the host and the other host.

2. The method according to claim 1, the resolving further comprising:
receiving, via the computer, a first response from at least one of the host and the other host.

3. The method according to claim 1, the resolving further comprising:
receiving, via the computer, a response from the host and another response from the other host; and
comparing, via the computer, the response to the other response.

4. The method according to claim 1, wherein the resolving comprises:
generating and transmitting a first coordinating message to the host;
receiving a response from the host in response to the first coordinating message; and
generating and transmitting a second coordinating message to the other host in response to the received response.

5. The method according to claim 4, wherein the resolving further comprises receiving another response from the other host in response to the transmitted second coordinating message.

6. The method according to claim 1 wherein the first person is blocked from simultaneously virtually attending both the first virtual meeting and the second virtual meeting.

7. The method according to claim 1, wherein the resolving occurs during the time overlap of the first virtual meeting and the second virtual meeting.

8. The method according to claim 1, wherein the time overlap occurs due to a time extension of the first virtual meeting.

9. A computer system for meeting schedule conflict resolution, the computer system comprising:
one or more processors, one or more computer-readable memories, and program instructions stored on at least one of the one or more computer-readable memories for execution by at least one of the one or more processors to cause the computer system to:
receive a registration for a first virtual meeting, the registration including a first list of persons scheduled to virtually attend, a first meeting time, and a host;
receive a registration for a second virtual meeting, the registration including a second list of persons scheduled to virtually attend, a second meeting time, and another host;
identify a time overlap of the first meeting time and the second meeting time;
identify a meeting schedule conflict comprising a first person being in the first list and in the second list; and
resolve the meeting schedule conflict via generating and transmitting a coordinating message to at least one of the host and the other host.

10. The computer system according to claim 9, wherein the resolving further comprises: receiving a first response from at least one of the host and the other host.

11. The computer system according to claim 9, wherein the resolving further comprises:
receiving a response from the host and another response from the other host; and
comparing the response to the other response.

12. The computer system according to claim 9, wherein the resolving comprises:
generating and transmitting a first coordinating message to the host;
receiving a response from the host in response to the first coordinating message; and
generating and transmitting a second coordinating message to the other host in response to the received response.

13. The computer system according to claim 12, wherein the resolving further comprises receiving another response from the other host in response to the transmitted second coordinating message.

14. The computer system according to claim 9, wherein the first person is blocked from simultaneously virtually attending both the first virtual meeting and the second virtual meeting.

15. The computer system according to claim 9, wherein the resolving occurs during the time overlap of the first virtual meeting and the second virtual meeting.

16. The computer system according to claim 9, wherein the time overlap occurs due to a time extension of the first virtual meeting.

17. A computer program product for meeting schedule conflict resolution, the computer program product comprising a computer-readable storage medium having program instructions embodied therewith, wherein the program instructions are executable by a computer system to cause the computer system to:
receive a registration for a first virtual meeting, the registration including a first list of persons scheduled to virtually attend, a first meeting time, and a host;
receive a registration for a second virtual meeting, the registration including a second list of persons scheduled to virtually attend, a second meeting time, and another host;
identify a time overlap of the first meeting time and the second meeting time;
identify a meeting schedule conflict comprising a first person being in the first list and in the second list; and
resolve the meeting schedule conflict via generating and transmitting a coordinating message to at least one of the host and the other host.

18. The computer program product according to claim 17, wherein the resolving further comprises: receiving a first response from at least one of the host and the other host.

19. The computer program product according to claim 17, wherein the resolving further comprises:
receiving a response from the host and another response from the other host; and
comparing the response to the other response.

20. The computer program product according to claim 17, wherein the resolving comprises:
generating and transmitting a first coordinating message to the host;
receiving a response from the host in response to the first coordinating message; and
generating and transmitting a second coordinating message to the other host in response to the received response.
